(19) United States
(12) Patent Application Publication
(10) Pub. No.: US 2013/0282976 A1
(43) Pub. Date: Oct. 24, 2013

(54) SELF-PROTECTING MASS STORAGE SYSTEMS AND METHODS

(71) Applicant: 9LIVESDATA CEZARY DUBNICKI, Warsaw (PL)

(72) Inventor: Cezary Dubnicki, Warsaw (PL)

(73) Assignee: 9livesdata Cezary Dubnicki, Warsaw (PL)

(21) Appl. No.: 13/867,672

(22) Filed: Apr. 22, 2013

Related U.S. Application Data
(60) Provisional application No. 61/636,677, filed on Apr. 22, 2012.

(51) Int. Cl. G06F 12/00

(52) U.S. Cl. CPC G06F 12/00
USPC 711/112; 711/154

(57) ABSTRACT

Method and systems directed to implementing a primary storage scheme and a secondary storage scheme on a common storage system are disclosed. One such system includes at least one storage device, a primary data storage module and a secondary data storage module. Each of the storage devices includes a plurality of storage mediums. Further, the primary data storage module is configured to store primary data in the storage device(s) in accordance with a primary storage method employing a first resiliency scheme. In addition, the secondary storage module is configured to store secondary data based on the primary data in the storage device(s) in accordance with a secondary storage method employing a second resiliency scheme such that a resiliency of recovering information composed by the primary data is at least cumulative of a resiliency of the first resiliency scheme and a resiliency of the second resiliency scheme.

### RELATED APPLICATION INFORMATION

This application claims priority to provisional application Ser. No. 61/636,677 filed on Apr. 22, 2012, incorporated herein by reference.

### BACKGROUND

1. Technical Field

The present invention relates to storage schemes, and more particularly to secondary storage schemes.

2. Description of the Related Art

The current state of the art of primary mass storage solutions are typically based on hard disk drives, SDD storage devices or combination of both. Three types of primary storage is commonly defined: direct-attached storage (DAS), which attaches to individual workstations and computers and cannot be used directly from outside the network in which DAS is implemented; storage area network (SAN) solutions, which export block-level interfaces, such as fiber channel over internet protocol (FCIP) and Internet Small Computer System Interface (iSCSI) over a network to be used by clients; and network-attached storage (NAS), which comprises NAS servers, each exporting one or more file systems to be used over a network by clients with protocols such as Network File System (NFS) and Server Message Block (SMB)/Common Internet File System (CIFS). An NAS server can be a single node, or a cluster of nodes, that distributes the client load automatically among cluster nodes.

There are many different solutions for implementing a backup of primary mass storage that are on the market today. The versatile and expensive data-center solutions are based on specialized backup applications, such as Symantec NetBackup, which requires a substantial amount of specialized hardware, including a backup server, media servers and backup targets, which can be tape libraries or disk-based devices. Other backup solution products deliver so-called continuous data protection, in which written data is intercepted on the client, for example by a filter driver, and sent to a separate backup target.

Traditionally, a backup target device was a single tape device or a tape robot, for larger installations. In recent years, other targets have been becoming more popular. One target class is disk-based devices, which usually provide deduplication of backup data. Examples of such devices include EMC Data Domain deduplication appliances. Disk-based targets can be a single node appliance or a cluster, as in the case of NEC HYDRAstor or ExaGrid products.

More recently, cloud backup has emerged, in which data is sent to a backup cloud, possibly over Internet. A subset of such solutions is based on a pay-as-you go concept, where backup service is provided by a service provider with fees that are based on usage.

Primary storage usually employs a resiliency schema which allows for automatic recovery from a pre-defined number of hardware failures. Examples of such schemata include Redundant Array of Independent Disks schemes (RAID), such as RAID-5 tolerating one disk failure and RAID-6 tolerating two disk failures. Secondary storage can employ its own resiliency schema, which can also be based on RAID solutions, or more elaborate approaches, such as erasure codes. For example, in NEC HYDRAstor, large configurations can tolerate three disk and three node failures using erasure codes.

### SUMMARY

One embodiment of the present invention is directed to a storage system including at least one storage device, a primary data storage module and a secondary data storage module. Each of the storage devices includes a plurality of storage mediums. Further, the primary data storage module is configured to store primary data in the storage device(s) in accordance with a primary storage method employing a first resiliency scheme. In addition, the secondary storage module is configured to store secondary data based on the primary data in the storage device(s) in accordance with a secondary storage method employing a second resiliency scheme such that a resiliency of recovering information composed by the primary data is at least cumulative of a resiliency of the first resiliency scheme and a resiliency of the second resiliency scheme.

Another embodiment of the present invention is directed to a storage system including a plurality of storage devices, a primary data storage module and a secondary data storage module. Each of the storage devices includes a respective plurality of storage mediums. The primary data storage module is configured to store primary data in the storage devices in accordance with a primary storage method employing a first resiliency scheme. Here, the primary data storage module is configured to store a first primary data block of the primary data by distributing different fragments of the first primary data block across at least a subset of the storage mediums of a first storage device of the plurality of storage devices and to store a second primary data block of the primary data by distributing different fragments of the second primary data block across at least a subset of the storage mediums of a second storage device of the plurality of storage devices. The secondary storage module is configured to store secondary data based on the primary data in accordance with a secondary storage method employing a second resiliency scheme, where the secondary storage module is configured to compute secondary data fragments from at least a subset of the fragments of the first primary data block and from at least a subset of the fragments of the second primary data block. The secondary storage module is further configured to recover information in the first primary data block by computing at least one lost fragment directly from at least one fragment of the subset of fragments of the second primary data block and from at least one of said secondary data fragments.

Another embodiment is directed to a storage system including a plurality of storage device nodes, a primary data storage module and a secondary storage module. Each of the nodes includes a plurality of different storage mediums. Further, the primary data storage module is configured to store a first primary data block of primary data on a first node of the plurality of storage device nodes in accordance with a primary storage method by distributing different fragments of said first primary data block across the storage mediums of the first node. The primary data storage module is further configured to store a second primary data block of the primary data on a second node of the plurality of storage device nodes by distributing different fragments of the second primary data block across the storage mediums of the second node. In addition, the secondary storage module is configured to store secondary storage data including data that is redundant of the first primary data block in accordance with a secondary storage method by distributing fragments of the secondary storage data across different storage device nodes of the plurality of storage device nodes, where at least a portion of the secondary storage data is stored on one of the storage mediums of the second node on which at least a portion of the second primary data block is stored or is stored on one of the storage mediums of the first node on which at least a portion of said first primary data block is stored.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a prior art storage system;

FIGS. 2 and 3 are high-level block diagrams of storage systems in accordance with exemplary embodiments of the present invention;

FIG. 4 is a high-level flow diagram of a method for storing data in accordance with an exemplary embodiment of the present invention;

FIG. 5 is a high level block diagram of a partition configuration of a storage medium in accordance with an exemplary embodiment of the present invention;

FIG. 6 is a high-level flow diagram of a method for storing data using separate partitions for primary and secondary data in accordance with an exemplary embodiment of the present invention;

FIG. 7 is a high-level block diagram of a storage system having cumulative resiliency in accordance with an exemplary embodiment of the present invention; and

FIG. 8 is a high-level block diagram of a storage system that employs primary data of a primary storage scheme in a secondary storage scheme in accordance with an exemplary embodiment of the present invention.

### DETAILED DESCRIPTION OF PREFERRED EMBODIMENTS

Prior to discussing exemplary embodiments of the present invention in detail, it should be noted that “primary mass storage” or “primary data storage” is referred to as mass storage or data storage, respectively, that is accessible with input/output operations (not directly with CPU) and which is used for data in active use by a system. In addition, “primary storage data” and “primary data” should be understood to mean data that is stored in primary mass storage or primary data storage in accordance with a primary mass storage or primary data storage scheme. In turn, “secondary storage” is defined as storage used to store backups of primary storage. Similarly, “secondary storage data” and “secondary data” should be understood to mean data that are backups of primary storage data.

Exemplary methods and systems of the present invention described herein can combine primary and secondary storage within one logical device described as self-protecting mass storage (SPMS). SPMS can be configured to ensure a predetermined failure resiliency level as delivered by current solutions, which separate primary storage from secondary storage devices. In particular, the exemplary embodiments described herein intelligently combine primary and secondary storage schemes on a common hardware storage system in a way that ensures that the resiliencies of the primary storage scheme and the secondary storage scheme are at least cumulative. Thus, the schemes can provide the same or better resiliencies then known solutions, but employ substantially less hardware resources. In addition, in accordance with other exemplary aspects, to substantially reduce overhead, the primary storage scheme and the secondary storage scheme can both reference certain stored fragments that are used in common for both schemes. As discussed in more detail herein below, in one exemplary embodiment, the total resiliency overhead for a data block which belongs to both primary and secondary data is 70%, whereas in a current solution using separate primary/secondary data systems, the total resiliency overhead is 170%.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that certain blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

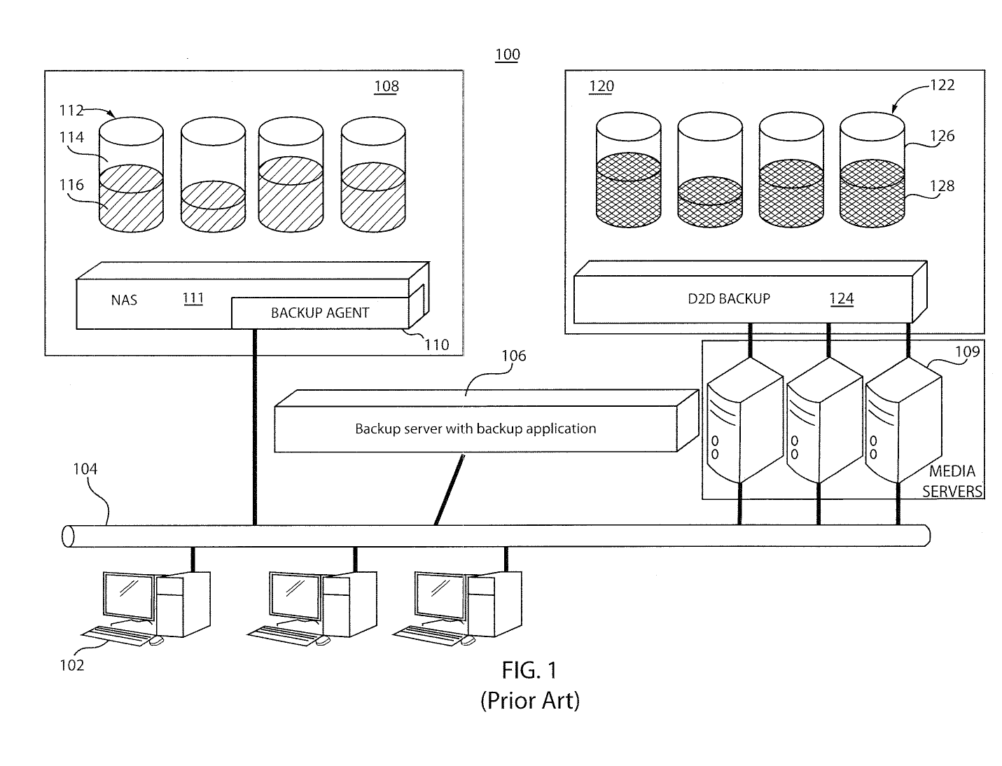

Referring now to the drawings in which like numerals represent the same or similar elements and initially to FIG. 1, to better illustrate exemplary aspects of the present invention, a prior art storage system 100 is illustratively depicted. The storage system 100 may include client computing devices 102, such as personal computers, that are connected to a bus or network 104 to communicate with an NAS system 108, backup server with a backup application 106 and media servers 109, which in turn backup data through a disk-to-disk (D2D) backup system 120 including a backup application 124. Here, the NAS system 108 and the D2D backup system 120 include storage mediums 112 and 122, respectively, which are implemented as hard-disks. The storage mediums 112 of the NAS system 108 store primary data 116 and include free space 114 reserved for additional data. Further, the storage mediums 122 in the separate D2D system 120 store secondary storage data 128 as backup for the primary data 116 and include free space 126 for the storage of additional secondary storage data.

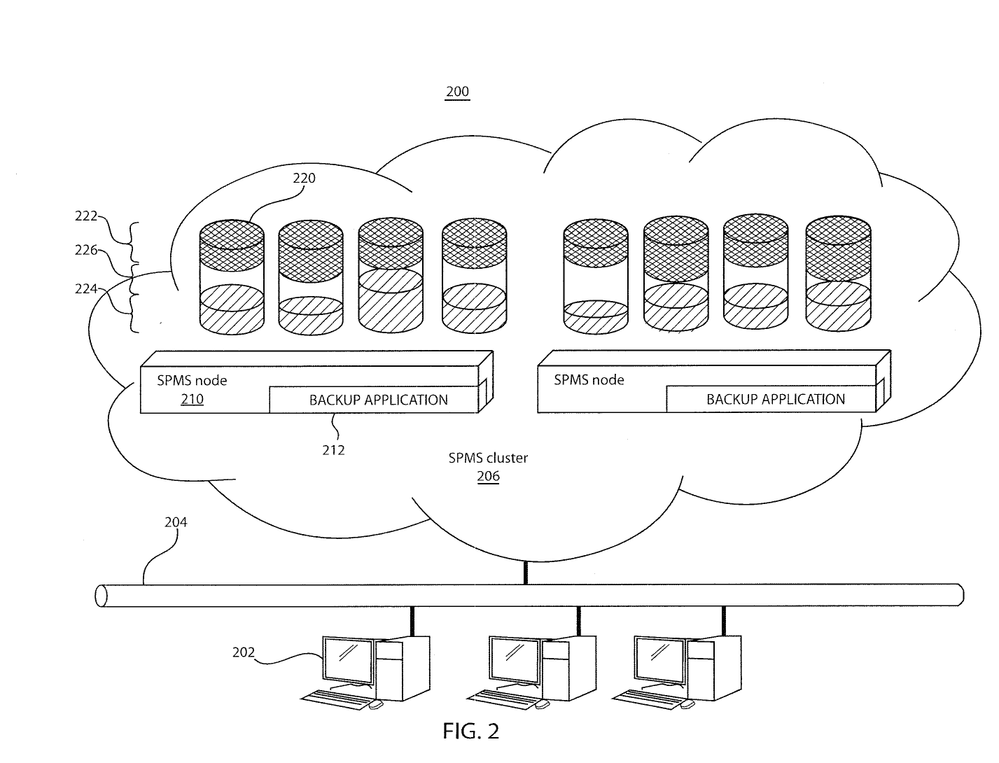

In contrast, in accordance with exemplary embodiments of the present principles, primary and secondary storage data may be stored in the same media space, for example, a hard drive space, used for both purposes of storing primary storage data as well as backup data. For example, as illustrated in FIG. 2, an SPMS system 200 can include client computing devices 102, such as personal computers, that are connected to a bus or network 104 to communicate with an SPMS cluster 206 of SPMS nodes 210. Here, each SPMS node 210 includes a plurality of storage mediums 220 including primary storage data 224 in the storage mediums and second storage data 222 that collectively backup the primary storage data 224. As illustrated in FIG. 2, each of the storage mediums 220 include a portion of the primary storage data as well as a portion of storage data. In addition, as discussed in more detail herein below, each of the storage mediums 220 also include free space 226 that can be dynamically allocated to store primary data or secondary data, as needed.

The system 200 has also a built-in backup application 212 which seamlessly provides backups for primary data to the devices 210 and restores from it onto itself in case of failure of a device component (e.g., single disk failure). As a result, backup architecture is dramatically simplified, as there is no longer a need for backup and media servers, as employed in the system of FIG. 1.

Although primary and secondary data can share the same media space in SPMS, both types of data can be stored with independent failure-resiliency schemas, such as, for example, software RAID and erasure codes. In preferred embodiments, the primary and secondary data can be stored in such a way that backup of a primary data block is placed on nodes and disks different from nodes and disks on which this primary data block resides. In accordance with preferred embodiments, resiliency schemas of primary and secondary storage can be different, but they are independent in such a way that lost primary storage data can be recovered from backup secondary storage data in case of a single failure or a number of pre-defined failures.

As discussed herein below, SPMS can be configured in such a way that one storage system including both primary and secondary storage data can have a resiliency that is at least cumulative of the resiliency of the primary storage scheme and the resiliency of one or more secondary storage schemes. For example, assume that the Primary Storage Resiliency is 0 node failures and 1 disk drive, i.e. the scheme does not lose any data with any 1 disk failure. Further, also assume that the Secondary Storage Resiliency is 1 node failure and 3 disk failures; that is, the scheme does not lose any data with any 1 node failure or any 3 disk failures. In accordance with the secondary storage schemes described herein below, the total storage resiliency of the SPMS system with both of these resiliencies combined is cumulative if one or both conditions hold: a) node failure resiliency is at least as good as a sum of node failure resiliencies for primary and secondary storage (i.e. 0+1=1 in this example); and b) the disk level resiliency is at least as good as a sum of disk failure resiliencies for primary and secondary storage (i.e. 1+3=4 in this example). To achieve the cumulative property, the system should carefully place backup or secondary data of primary data on nodes and disks as discussed herein below.

Thus, SPMS can deliver the same or improved resiliency guarantees as current solutions.

Furthermore, SPMS can offer better performance in both accessing primary data and accessing secondary data because of improved utilization of hardware resources. The SPMS approach can also deliver the same level of performance as separate solutions, but with less hardware, resulting in lower power consumption and lower footprint. Moreover, as also discussed in more detail herein below, total redundancy overhead on primary and secondary data can be reduced by permitting the primary storage and secondary storage schemes to employ certain data in common when compared to such overhead in two separate systems, assuming the same failure resiliency in both cases. Here, the secondary storage scheme need not create and store a copy of the primary storage data.

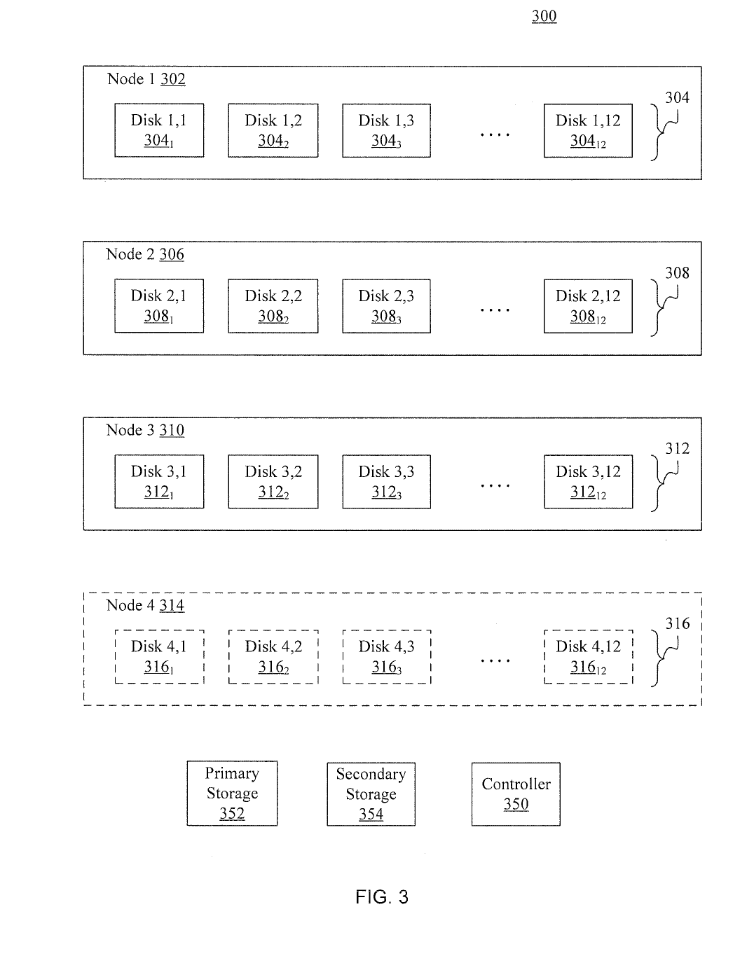

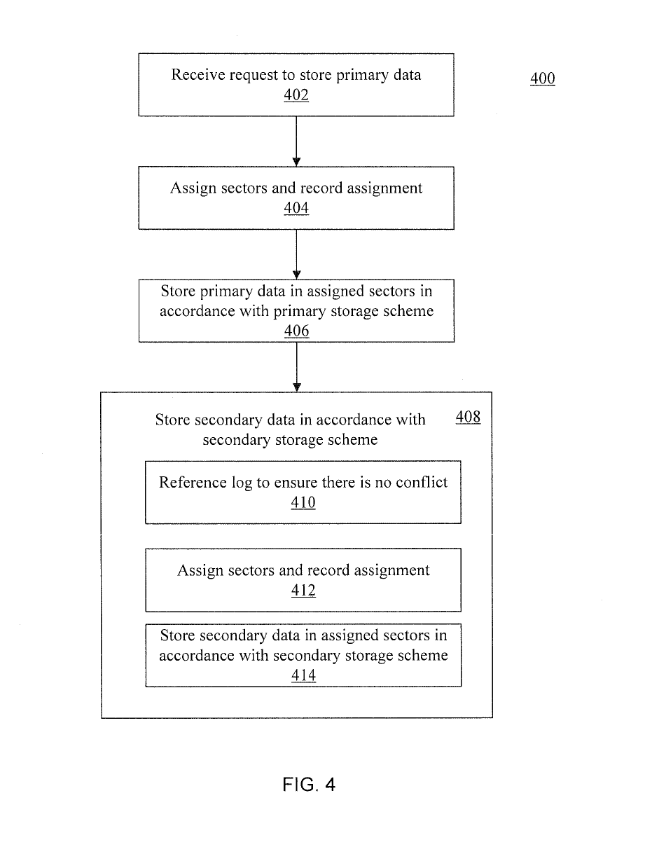

Referring now to FIGS. 3 and 4, with continuing reference to FIG. 2, an exemplary SPMS system 300 and an exemplary method 400 for storing data in accordance with an SPMS embodiment are respectively depicted. The SPMS system 300 is built as a cluster of multiple, in this example 3, identical storage devices or storage device nodes 302, 306 and 310, with each node containing a fixed number of hard disks, 12 in this example. As discussed further herein below, the system 300 can optionally include a fourth storage device or storage device node 314 to ensure that the system achieves a resiliency that is cumulative of the resiliencies of primary and secondary storage schemes. The system 300 also includes a primary storage module 352, a secondary storage module 354 and a controller 350. In each of the embodiments described herein, the primary storage module is composed of modules implemented across the storage device nodes, such as nodes 210. In addition, in each of the embodiments described herein, the secondary storage module and the controller are composed of respective modules implemented across the storage device nodes, such as within the backup application 212. Here, in the system 300, the node 302 includes a set of storage mediums 304, implemented as hard disks, comprising disks 304₁-304₁₂. Further, the node 306 similarly includes a set of storage mediums 308 comprising disks 308₁-308₁₂, the node 310 includes a set of storage mediums 312 comprising disks 312₁-312₁₂ and the node 314 includes a set of storage mediums 316 comprising disks 316₁-316₁₂. The system 300 can be used as the SPMS cluster 206. Further, the cluster of nodes 302, 306, 310 and optionally 314 can be used as a clustered NAS server, with all disks used for storing/reading primary data. In accordance with one example, in which three nodes 302, 306 and 310 are employed, written primary data is saved on each of the nodes with a RAID-5 resiliency schema implemented in software within each given node. The backup or secondary storage scheme part of this SPMS device or system supports deduplication based on variable-sized blocks cut with Rabin fingerprinting. The built-in backup application periodically, for example, stores all recently modified files as backup with resiliency schema based on software-implemented erasure codes dispersing fragments of variable-sized blocks across cluster nodes in such a way that after one node failure backup data can be recreated using fragments from other nodes. This is achieved by cutting a data block into 8 original fragments, computing 4 redundant fragments, and distributing 4 fragments to each of the nodes 302, 306 and 310 with each fragment going to a separate disk on the respective node. To ensure that the resiliency of the primary and secondary data is cumulative, the secondary storage scheme can be implemented by cutting a data block into 8 original fragments, computing 4 redundant fragments, and distributing 4 fragments to each of three nodes of 302, 306, 310 and 314, excluding the node which keeps the primary copy of this block, with each fragment going to a separate disk on the respective node. The resulting resiliency is one node failure or 4 disk failures. Since a software RAID-5 is used for blocks containing primary data, both resiliency schemas can coexist within one disk partition, so disk space can be dynamically shared between primary and secondary storage, for example, as discussed herein below with respect to FIG. 4.

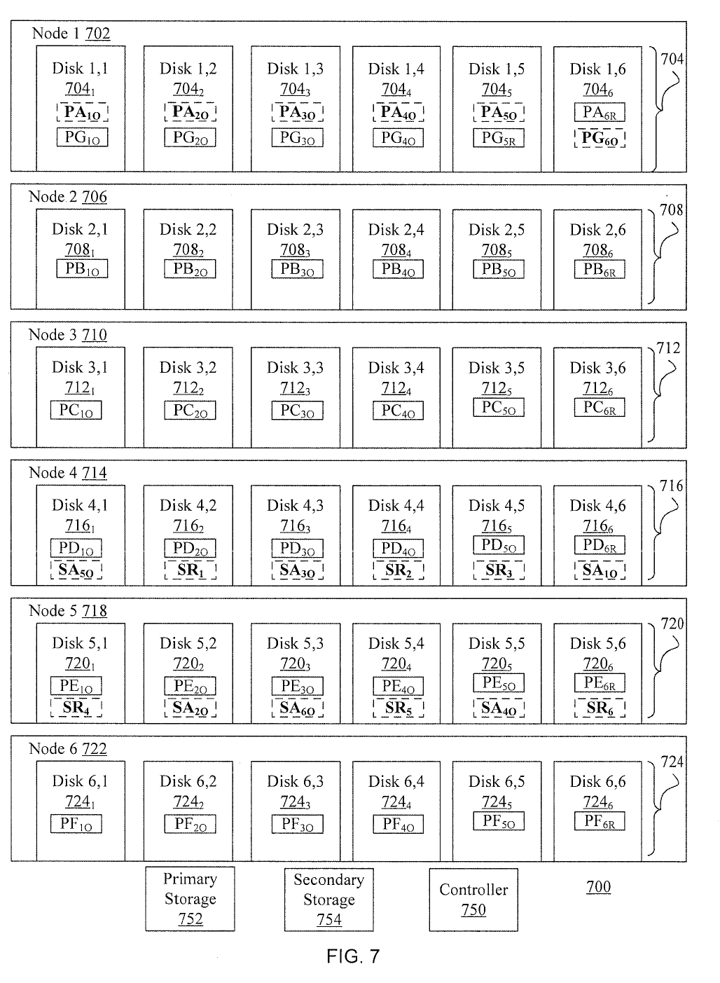

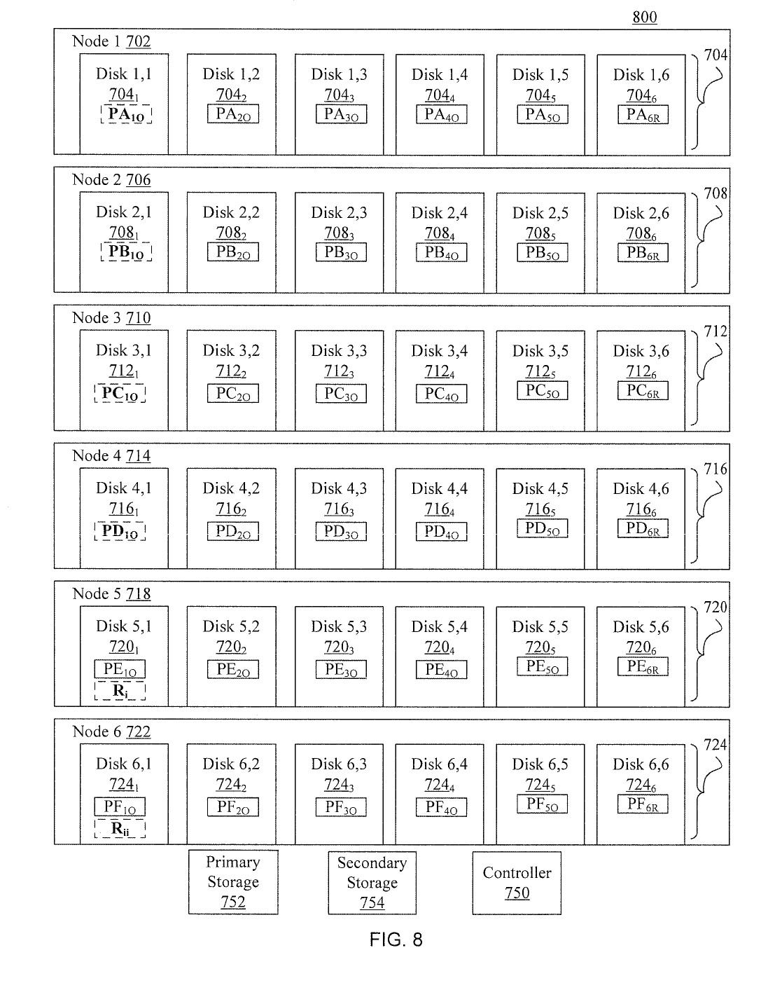

As noted above, FIG. 4 illustrates a method 400 for storing data in accordance with an exemplary SPMS embodiment. In particular, the method 400 can be employed where a given storage medium has only one partition that is shared between primary data and secondary data. The method 400 can begin at step 402, at which the SPMS system 300 receives a request to store primary data. For example, one of the client devices 202 can provide the request to the system 300. At step 404, the controller 350 can assign sectors in the storage mediums of one or more nodes of the system 300 and can record the assignment in a log. Here, the log can be referenced so that the primary data is not stored in one or more locations at which other primary data or secondary data is stored for, for example, resiliency purposes. At step 406, the primary storage module 352 can store the primary data in the assigned sectors. Steps 404 and 406 can be performed in accordance with a primary data storage scheme, such as, for example, RAID-5. At step 408, secondary storage data can be stored in the system in accordance with a secondary storage scheme, which, for example, can be based on erasure codes, as indicated above. Step 408 can be triggered, for example, by one or more of the clients 202 or can be triggered by the controller 350 as a result scheduled backups of the primary data. To implement step 408, the method 400 can proceed to step 410, at which the controller 350 can reference the log to ensure that secondary storage data is not stored in one or more locations at which other primary data or secondary data is stored for, for example, resiliency purposes. At step 412, the controller 350 can assign sectors in the storage mediums of one or more nodes of the system 300 and can record the assignment to the secondary storage data in the log. At step 414, the secondary storage module 354 can store the secondary data, which is a backup of the primary data, in accordance with the secondary storage scheme. It should be noted that in alternative embodiments, the system can be simplified by designing the secondary storage scheme to ensure automatically that resiliencies of the secondary data and primary data are maintained without reference to a log, as described, for example, with respect to FIGS. 7 and 8 below. As discussed in more detail herein below, the secondary storage module 354 can be configured to store the secondary storage data such that the resiliency of system is cumulative of the resiliency of the primary data storage scheme and the resiliency of the secondary data storage scheme. Further, to substantially reduce the total resiliency overhead, the system can be configured such that copies of the primary data need not be made by the secondary storage module 354.

In another variation of the embodiment of the SPMS system 300, hardware RAID-5 is used for primary data, which involves setting up separate partitions for primary and secondary data on the same disk. In such a case, sharing of disk space among primary and secondary data is less dynamic but can still be achieved by creating a fixed small number of partitions on each disk, assigning initially one of them to primary data and another one to secondary data, and later assigning a subsequent next free partition to primary or secondary data based on the actual demand. Such assignments can be done off the critical path when, for example, all partitions currently assigned to a specific data type (primary or secondary) reach a high combined pre-defined utilization level or threshold, for example, a given percentage within the range of 80%-90%.

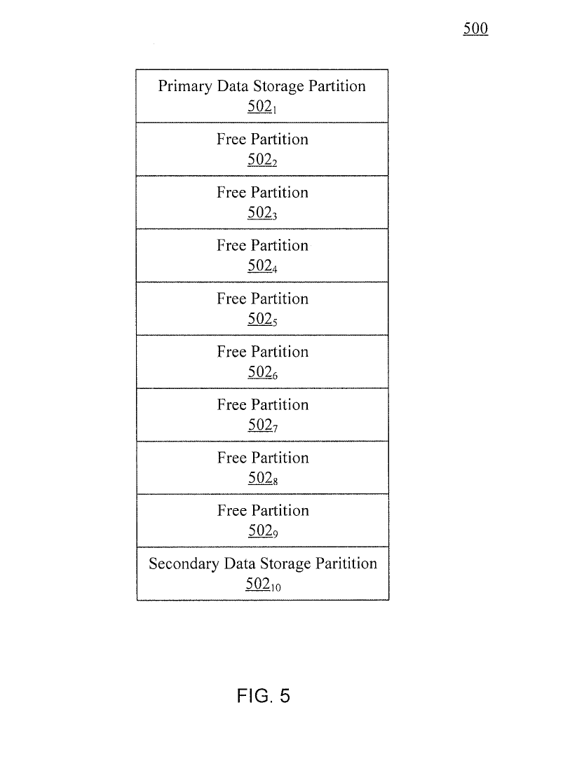

To illustrate this variation, reference is made to FIG. 5, illustrating an exemplary partition scheme that can be implemented in each one of the storage mediums of the exemplary SPMS system 300, as well as in other system embodiments described herein. Here, each disk is divided into 10 equal-sized partitions, numbered from 1 to 10. In particular, as illustrated in FIG. 5 in this example, a storage medium, generally denoted as element 500, can be partitioned into partitions 502₁-502₁₀. These partitions are divided into 3 disjoint groups: partitions used for primary data, unused partitions and partitions used for keeping of backups of primary data. In any given moment all partitions numbered X (short name set-X) on all nodes belong exclusively to one of these three groups. Initially, all partitions number 1 (set-1) on each node are organized into hardware RAID-5 to keep primary data. All partitions number 10 on all disks and all nodes (set-10) are used to keep backups of primary data. Partitions number 2 . . . 9 are unused. For example, FIG. 5 illustrates an initial setup of the partitions. Here, partition 502₁ is assigned for primary data storage while partition 502₁₀ is allocated for secondary data storage. The remaining partitions 502₂-502₉ are denoted as free partitions.

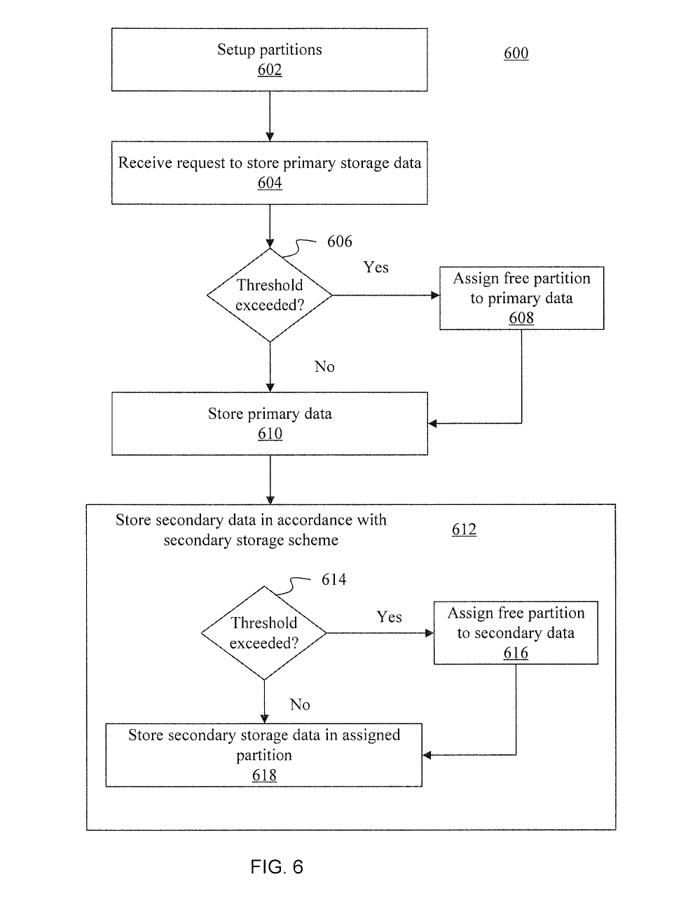

FIG. 6 illustrates an exemplary method 600 for storing data in accordance with an SPMS partition scheme. The method 600 can begin at step 602, at which the controller 350 of the system 300 sets up the partitions, as illustrated in FIG. 5.

At step 604, the controller 350 can receive a request to store primary storage data. When a space for a given type of data (i.e. primary or backup) is close to full, the controller 350 of the SPMS system allocates the next unused set of partitions for this type of data. For example, when all partitions numbered 1 of the node(s) are close to being full, all partitions numbered 2 (i.e. set-2) or 502₂ are allocated to primary data (provided they have not been allocated yet to backups). Thus, the method 600 can proceed to step 606, where the controller 350 can determine whether a storage threshold is exceeded. For example, as noted above, when the partitions allocated to primary data are at or above 80%, or 90%, full in each of the storage mediums, for example, then the system can allocate one more partition from the set of free partitions of each storage medium in the node to primary data. Thus, if the threshold is exceeded at step 606, then the method can proceed to step 608, at which the controller 350 allocates a free partition to primary data. For example, in the configuration illustrated in FIG. 5, the controller 350 can allocate the partition 502₂ to primary storage data. Thereafter, the method can proceed to step 610. If, at step 606 the controller 350 determines that the threshold is not exceeded, then the method also proceeds to step 610, at which the primary storage module 352 stores the primary data in partitions allocated for primary storage data, such as partition 502₁. For example, when NAS data is being written, it is placed in free blocks of partitions assigned to primary data, according to, for example, the RAID-5 scheme. The assignment of given data to a specific cluster node can be done based on a file name (i.e. a given file data always goes to a given node); or a given directory (i.e. all files in a given directory go to a given node); or primary data blocks can be interleaved among nodes for load balancing: for example 1 MB of subsequent data blocks written are sent to one node together with RAID-5 redundant information, and the next 1 MB of blocks are sent to the next cluster node and so on. Here, a data block can be fragmented, such that original fragments and a redundant fragment is dispersed between storage mediums of a given node, such as a subset of storage mediums 304₁-304₁₂ of node 302.

At step 612, secondary storage data can be stored in the system in accordance with a secondary storage scheme, which, for example, can be based on erasure codes, as indicated above. Step 612 can be triggered, for example, by one or more of the clients 202 or can be triggered by the controller 350 as a result scheduled backups of the primary data, as discussed above with respect to the method 400. Similar to step 606, at step 614, the controller 350 can determine whether a storage threshold is exceeded. For example, as noted above, when the partitions allocated to secondary data are at or above 80%, or 90%, full in each of the storage mediums, for example, then the system can allocate one more partition from the set of free partitions of each storage medium in the node to secondary data. Thus, if the threshold is exceeded at step 614, then the method can proceed to step 616, at which the controller 350 allocates a free partition to secondary data. For example, in the configuration illustrated in FIG. 5, the controller 350 can allocate the partition 502₉ to secondary storage data. Thereafter, the method can proceed to step 618. If, at step 614 the controller 350 determines that the threshold is not exceeded, then the method also proceeds to step 618, at which the secondary storage module 354 stores the secondary data in partitions allocated for secondary storage data, such as partition 502₁₀. The secondary storage scheme applied by the secondary storage module 354 can support deduplication based on variable-sized blocks cut with Rabin fingerprinting. On backup, recently written data can be read off primary data partitions and copied into partitions assigned to backups.

The resulting SPMS system in accordance with this embodiment offers much better performance than current solutions of a separate NAS and disk-based appliance for backups, as in this SPMS embodiment, all spindles can be employed to handle NAS load in a moment when backup is not running; whereas with two separate systems, spindles of the backup appliance cannot be employed to handle NAS load.

Moreover, the usage of disk space is much more efficient than with schemes employing two separate systems. This is because, in SPMS, disk space can be assigned to primary or secondary data based on actual storage needs of a given data type with dynamic assignment of subsequent sets of partitions using a subdivision of each disk into multiple partitions, such as 10. In contrast, with two separate systems, the disk space is allocated statically by assigning an entire disk to NAS or the backup appliance.

Another embodiment of the present invention is a single node SPMS system comprising 12 storage mediums, such as node 302 including 12 disks 304₁-304₁₂. This system provides NAS functionality using a primary storage data partition on each disk, and all of these partitions are organized, for example, in two sets, where each set of 6 disks is organized in hardware RAID-5. The backup portion of this SPMS supports backup deduplication. The built-in backup application uses a backup partition on each disk, and writes variable-sized data blocks cut with Rabin fingerprinting using a 3+3 erasure code resiliency schema (with 3 redundant fragments). In such an SPMS system, primary data can tolerate 1 disk failure and secondary data can tolerate 3 disk failures, where each fragment is sent to a different disk. In accordance with an alternative implementation, the built-in backup application writes variable-sized data blocks cut with Rabin fingerprinting using a 3+3 erasure code resiliency schema (with 3 redundant fragments). On backup, a variable-sized block is erasure-coded and its fragments are stored on a 6 disk set different from the set of disks which keeps primary data of this block, with each fragment stored on a different disk. In this implementation, the system, in total, can tolerate 4 disk failures, since for each block, its primary and secondary data are stored on a different set of disks. Thus, in this single node implementation, the resiliencies of the primary and secondary storage schemes are cumulative.

As discussed above, in accordance with other exemplary embodiments of the present invention, the secondary storage module and the secondary storage scheme can be configured to store secondary storage data on a cluster of nodes such that the resiliency of the SPMS system is cumulative of the resiliency of the primary data storage scheme and the resiliency of the secondary data storage scheme. The cumulative property can be achieved through step 408 and step 612 of the methods 400 and 600, respectively. For illustrative purposes, reference is made to FIG. 7, depicting an alternative embodiment of an SPMS system 700. The methods 300 and 400 can be implemented in system 700, with the primary storage module 752 acting as the primary storage module 352 to implement its corresponding steps of the methods 400 and 600, the secondary storage module 754 acting as the secondary storage module 354 to implement its corresponding steps of the methods 400 and 600 and the controller 750 acting as the controller 350 to implement its corresponding steps of the methods 400 and 600. For example, FIG. 7 illustrates a 6 node SPMS system 700, each node with 6 storage mediums. In this particular example, node 1 702 includes a set 704 of disks comprising disks 704₁-704₆, node 2 706 includes a set 708 of disks comprising disks 708₁-708₆, node 3 710 includes a set 712 of disks comprising disks 712₁-712₆, node 4 714 includes a set 716 of disks comprising disks 716₁-716₆, node 5 718 includes a set 720 of disks comprising disks 720₁-720₆, and node 6 722 includes a set 724 of disks comprising disks 724₁-724₆. This system uses local RAID-5 for primary data resiliency. Thus, at steps 406 and 610, a data block A can be stored as 5 primary original fragments PA_{1O}-PA₅₀ in storage mediums 704₁-704₅, respectively, and one primary redundant fragment PA_{6R} stored in storage medium 704₆, as illustrated in FIG. 7. Similarly, at steps 406 and 610, a second primary data block B can be stored as 5 primary original fragments PB_{1O}-PB₅₀ in storage mediums 708₁-708₅, respectively, and one primary redundant fragment PB_{6R} stored in storage medium 708₆, as illustrated in FIG. 7. Primary data blocks C, D, E and F, composed of original primary fragments PC_{1O}-PC₅₀, PD_{1O}-PD₅₀, PE_{1O}-PE₅₀, and PF_{1O}-PF₅₀, respectively, and primary redundant fragments PC_{6R}, PD_{6R}, PE_{6R}, and PF_{6R}, can be similarly formed and stored at steps 406 and 610 in storage nodes 710, 714, 718 and 722, as illustrated in FIG. 7. Of course, each node can store a plurality of different primary data blocks, with redundant fragments stored on different storage mediums. Thus, at steps 406 and 610, another data block G can be stored as 5 primary original fragments PG_{1O}-PG₄₀ and PG₆₀ in storage mediums 704₁-704₄ and 704₆ respectively, and one primary redundant fragment PB_{5R} stored in storage medium 704₅, as illustrated in FIG. 7.

In turn, at steps 414 and 618 secondary storage data can be stored in accordance with a secondary storage scheme. For example, to achieve the cumulative resiliency property, whenever there is a distribution across nodes, secondary storage data should be stored on nodes and disks which are different from nodes and disks keeping the “primary” data of this secondary data. For example, data to be saved to backup is cut into variable-sized blocks of expected 64 KB size using Rabin fingerprinting with an additional restriction that each resulting block contains data read from a primary partition of only one cluster node. Further, all variable-sized blocks which are new (i.e. not duplicates of already backuped blocks) are erasure-coded into 6 original fragments and 6 redundant fragments, and all fragments are written to 2 cluster nodes (6 fragments to each node) that are different from the cluster node which contains primary data of this block. Additionally, each fragment is stored in a different disk on these nodes (i.e. no disk keeps two fragments of the same block), in any partitions assigned for keeping secondary storage data, if the partition scheme is employed.

For example, as illustrated in FIG. 7, primary data to be backed up can be composed of 6 pieces of data denoted as PA_{1O}, PA_{2O}, PA_{3O}, PA_{4O}, PA_{5O}, and PG_{6O}, that can be copied and erasure-coded, as secondary storage data, into original fragments SA_{1O}, SA_{2O}, SA_{3O}, SA_{4O}, SA_{5O}, SA_{6O} and redundant fragments SR₁-SR₆ by the secondary storage module 754 in accordance with the secondary storage scheme. It should be noted that, in FIG. 7, a fixed block size is used for secondary storage for ease of illustration. However, in the preferred embodiments, variable-sized blocks cut with Rabin fingerprinting are used, as described above, to facilitate deduplication. Here, in FIG. 7, original fragments are stored in storage mediums 716₆, 720₂, 716₃, 720₅, 716₁ and 720₃, respectively, in storage nodes 714 and 718, which are different from the storage node 702, from which the primary data was obtained. The redundant fragments are distributed to storage mediums 716₂, 716₄, 716₅, 720₁, 720₄, and 720₆, respectively, on storage nodes 714 and 718, as illustrated in FIG. 7. As discussed above, the primary and secondary data can be stored in such way that backup of a primary data block is placed on nodes and disks different from nodes and disks on which this primary data block resides. Thus, here, the secondary storage module is configured to store secondary data such that any data block of the secondary data and a corresponding data block of the primary data from which the data block of the secondary data is based are stored on different storage mediums and different storage nodes of the system 700.

Similar to the example provided above, secondary data can be generated based on primary data stored in other nodes in the system 700, such as nodes 710 and 714, and can be stored in the storage mediums 704 and 708 of nodes 702 and 706 as secondary data in a similar manner. By storing the secondary data in this way, a resiliency of recovering information composed by, for example, data block A is at least cumulative of a resiliency of the resiliency scheme of RAID-5, in this example, and a resiliency of the resiliency scheme of the secondary storage method applied.

In particular, as a result of this scheme, the resiliency of primary data is one disk failure, whereas the resiliency of backup of such data is 6 disk failures and one node failure. Moreover, these two resiliency schemes are independent and robust in that a total combined data resiliency of such an SPMS system is at least cumulative. In particular, the system disk-level resiliency is 7 disk failures. Moreover, system node-level resiliency is two node failures, which is even better than cumulative.

As indicated above, in certain exemplary embodiments, primary data and secondary data resiliency schemas can use the same data to reduce total resiliency overhead. Thus, instead of creating one or more copies of the primary data for storage as secondary data, the storage system can, in the alternative, be configured to generate secondary data in the form of additional redundant information without creating a copy of the primary data. To ensure that resiliency is cumulative, as discussed above, the secondary storage module is configured to store secondary data such that any fragment of secondary data and a corresponding primary data block from which the fragment of the secondary data is based are stored on different storage mediums and different storage nodes of the system, such as system 800, discussed in detail herein below. Further, also to ensure cumulative resiliency, the secondary redundant fragments are computed based on primary fragments that are each taken from a different node (i.e., none of these primary fragments are taken from a node in which another primary fragment, taken to generate the redundant fragments, is stored) and each of these redundant fragments are stored on different nodes (i.e., no two of these redundant fragments are stored on a common node and none of the redundant fragments are stored on any node on which any of the primary fragments from which the redundant fragments are based are stored).

For example, reference is made to FIG. 8, which illustrates an embodiment of a secondary storage scheme that is alternative to the secondary storage scheme described above with respect to FIG. 7. Here, the secondary storage module 754 is configured to store secondary data without making a copy of primary data. For example, primary storage module 352 can perform steps 406 and 610 as discussed above with respect to FIG. 7. Here, in this example, the secondary storage module 754 stores a fixed block size of 4+2 erasure codes across nodes for secondary data resiliency schema. In particular, the secondary storage module 754, at steps 414 and 618, can reference primary data pieces PA_{1O}, PB_{1O}, PC_{1O}, and PD_{1O} stored in storage mediums 704₁, 708₁, 712₁, and 716₁, respectively, to form redundant fragments Rᵢ and Rᵢᵢ in accordance with an erasure coding scheme to be stored across nodes, such as nodes 718 and 722, as illustrated in FIG. 8. If any of the primary data pieces/fragments are lost, the secondary storage module 754 can recover information by computing lost fragments directly from the primary data as well as from the secondary data. For example, if fragment PA_{1O} was lost due to node failure of node 702, then the secondary storage module 754 can recover fragment PA_{1O} from, for example, fragments PB_{1O}, PC_{1O}, and PD_{1O} stored in storage mediums 708₁, 712₁, and 716₁ and from, for example, redundant fragment Rᵢ stored in storage medium 720₁. The remaining portions of the data block A stored in storage node 702 can be similarly recovered by the secondary storage module 754 from other secondary data similarly generated as described above with respect to redundant fragments Rᵢ and Rᵢᵢ and stored in other storage mediums. It should be noted that redundant fragments can be stored on any of the nodes of the system 700. However, to ensure cumulative resiliency, the restrictions noted above on generation and storage of the secondary data should be applied by the secondary storage module 754.

It should be noted that, in the example described above with respect to FIG. 8, the total resiliency overhead for a data block which belongs to both primary and secondary data is 70% (50% overhead of 4+2 erasure coding and 20% of 6-disk RAID-5); whereas in a current solution using separate primary/secondary data systems, the total resiliency overhead is 170% (because of an additional copy of data needed for backup). In this approach, backing up data does not require creation of another copy of the backed up data as in the current solution; instead, additional redundant data is computed and distributed according to the secondary data resiliency schema. Naturally, such a copy needs to be made when this data is overwritten in the primary storage.

To facilitate deduplication, across-node erasure codes can be computed with large segments aggregating multiple variable-sized blocks cut with Rabin fingerprinting. For example, subsequent variable sized blocks with expected size of 8 KB can be grouped together into 1 MB fragments (with padding as necessary), and next, using 4 such fragments from 4 different nodes, the erasure code procedure can compute 2 redundant fragments (assuming the same erasure coding as in the example in FIG. 8). Since padding up to 1 MB fragments with blocks of expected size 8 KB creates on average 4 KB wasted space, the total resiliency overhead will be very close to 70%, as in the example in FIG. 8.

As indicated above, in the embodiments in which copies need not made and data is shared between primary and secondary storage schemes, the resiliencies can still be cumulative. For example, assume that on backup no copy is made, primary resiliency is implemented within each node and secondary resiliency is implemented across nodes (i.e., all redundant and original fragments are spread among different nodes and disks). Assume also that the primary resiliency is P disk failures and the secondary resiliency is S disk failures so that the cumulative resiliency is P+S disk failures.

Consider any P+S disk failures. If the maximum number of disks failed within each node is not more than P, then the primary resiliency scheme is employed by the controller 750 to recover primary data. Otherwise, the maximum number of disks failed within one node is greater than P and, since the total number of disks failed is P+S for cumulative resiliency, the total number of nodes with at least one disk failed is not more than S. In such a case, the secondary storage module 754 can use the secondary resiliency to recover all primary data because the secondary resiliency scheme can recover data with up to S disks failed in different nodes. In both cases, after recovering all primary data, the secondary storage module 754 can recompute all redundant information for secondary and primary data.

For example, in the example noted above with respect to FIG. 8, the primary resiliency is 0 node failures and 1 disk failure and the secondary resiliency is 2 node failures and 2 disk failures. The total cumulative resiliency is thus 2 node failures and 3 disk failures. In accordance with the scheme described above with respect to FIG. 8, any 2 node failures can be recovered using erasure codes. Further, any 3 disk failures can also be recovered. If only one disk failed on any given node, the system can recover all primary data with RAID-5 resiliency using remaining alive disks from this node. If more than one disk failed on any given node then in each column there are not more than 2 disk failures (since total number of failed disks is 3). In such a case, the system can use erasure codes to recover all primary data in each column. With primary data recovered in both cases, the system, for example, the controller 350 and 750, can recompute all missing redundant fragments for both primary and secondary resiliencies. Thus, even if data is shared between primary and secondary storage schemes as described above, the resiliency of the system is cumulative of the resiliencies of the primary data storage scheme and the secondary data storage scheme.

Having described preferred embodiments of SPMS systems, methods and devices (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A storage system comprising:
at least one storage device including a plurality of storage mediums;
a primary data storage module configured to store primary data in said at least one storage device in accordance with a primary storage method employing a first resiliency scheme; and
a secondary storage module configured to store secondary data based on said primary data in said at least one storage device in accordance with a secondary storage method employing a second resiliency scheme such that a resiliency of recovering information composed by said primary data is at least cumulative of a resiliency of said first resiliency scheme and a resiliency of said second resiliency scheme.

2. The system of claim 1, wherein the secondary storage module is configured to store said secondary data such that any fragment of said secondary data and a corresponding data block of said primary data from which the fragment of said secondary data is based are stored on different storage mediums of said plurality of storage mediums.

3. The system of claim 1, wherein said at least one storage device is one storage node and wherein said at least one storage medium is a plurality of disks.

4. The system of claim 1, wherein said plurality of storage mediums is a plurality of disks, wherein said at least one storage device is a cluster of storage nodes and wherein each of said storage nodes includes a different set of disks of said plurality of disks.

5. The system of claim 4, wherein the secondary storage module is configured to store said secondary data such that any fragment of said secondary data and a corresponding data block of said primary data from which the fragment of said secondary data is based are stored on different nodes of said cluster of storage nodes.

6. The system of claim 1, wherein at least one of said storage mediums consists of one partition and wherein at least a portion of said secondary data and at least a portion of said primary data are stored in the partition.

7. The system of claim 1, wherein at least a portion of said secondary data is stored in a partition of a given storage medium of said storage mediums allocated for secondary storage data and wherein at least a portion of said primary data is stored in a partition of said given storage medium allocated for primary storage data.

8. The system of claim 7, wherein said given storage medium further includes at least one free partition.

9. The system of claim 8, further comprising:
a controller configured to allocate a partition of said at least one free partition to primary storage data in response to determining that said partition of said given storage medium allocated for primary storage data exceeds a storage threshold or to allocate said partition of said at least one free partition to secondary storage data in response to determining that said partition of said given storage medium allocated for secondary storage data exceeds said storage threshold.

10. The system of claim 1, wherein said secondary storage module is further configured to store at least one copy of said primary data and to generate said secondary data from said at least one copy.

11. A storage system comprising:
a plurality of storage devices, each of the storage devices including a plurality of storage mediums;
a primary data storage module configured to store primary data in said storage devices in accordance with a primary storage method employing a first resiliency scheme, wherein the primary data storage module is configured store a first primary data block of said primary data by distributing different fragments of said first primary data block across at least a subset of the storage mediums of a first storage device of said plurality of storage devices and to store a second primary data block of said primary data by distributing different fragments of said second primary data block across at least a subset of the storage mediums of a second storage device of said plurality of storage devices; and
a secondary storage module configured to store secondary data based on said primary data in accordance with a secondary storage method employing a second resiliency scheme, wherein the secondary storage module is configured to compute secondary data fragments from at least a subset of the fragments of said first primary data block and from at least a subset of the fragments of said second primary data block and to recover information in said first primary data block by computing at least one lost fragment directly from at least one fragment of said subset of fragments of said second primary data block and from at least one of said secondary data fragments.

12. The system of claim 11, wherein the resiliency of said first resiliency scheme is different from the resiliency of said second resiliency scheme.

13. The system of claim 11, wherein the secondary storage module is configured to store said secondary data such that any given fragment of said secondary data and corresponding fragments of said primary data from which the given fragment of said secondary data is based are stored on different storage mediums of said plurality of storage mediums.

14. The system of claim 11, wherein said plurality of storage mediums is a plurality of disks, wherein said at least one storage device is a cluster of storage nodes and wherein each of said storage nodes includes a different set of disks of said plurality of disks.

15. The system of claim 14, wherein the secondary storage module is configured to store said secondary data such that any given fragment of said secondary data and corresponding fragments of said primary data from which the given fragment of said secondary data is based are stored on different nodes of said cluster of storage nodes.

16. The system of claim 11, wherein at least one of said storage mediums consists of one partition and wherein at least a portion of said secondary data and at least a portion of said primary data is stored in the partition.

17. The system of claim 11, wherein at least a portion of said secondary data is stored in a partition of a given storage medium of said storage mediums allocated for secondary storage data and wherein at least a portion of said primary data is stored in a partition of said given storage medium allocated for primary storage data.

18. The system of claim 17, wherein said given storage medium further includes at least one free partition.

19. The system of claim 18, further comprising:
a controller configured to allocate a partition of said at least one free partition to primary storage data in response to determining that an amount of data stored in said partition of said given storage medium allocated for primary storage data exceeds a storage threshold or to allocate said partition of said at least one free partition to secondary storage data in response to determining that an amount of data stored in said partition of said given storage medium allocated for secondary storage data exceeds said storage threshold.

20. A storage system comprising:
a plurality of storage device nodes, wherein each of said nodes includes a plurality of different storage mediums;
a primary data storage module configured to store a first primary data block of primary data on a first node of said plurality of storage device nodes in accordance with a primary storage method by distributing different fragments of said first primary data block across the storage mediums of said first node and to store a second primary data block of the primary data on a second node of said plurality of storage device nodes by distributing different fragments of said second primary data block across the storage mediums of said second node; and
a secondary storage module configured to store secondary storage data including data that is redundant of said first primary data block in accordance with a secondary storage method by distributing fragments of said secondary storage data across different storage device nodes of said plurality of storage device nodes, wherein at least a portion of said secondary storage data is stored on one of the storage mediums of said second node on which at least a portion of said second primary data block is stored or is stored on one of the storage mediums of said first node on which at least a portion of said first primary data block is stored.

21. The system of claim 20, wherein the primary storage method employs a first resiliency scheme, wherein the secondary storage method employs a second resiliency scheme that is different from the first resiliency scheme, and wherein the secondary storage module is further configured to store the secondary storage data such that a resiliency of recovering information in said primary data is cumulative of a resiliency of said first resiliency scheme and a resiliency of said second resiliency scheme.

22. The system of claim 21, wherein the secondary storage module is constrained to store said secondary storage data such that any given fragment of the fragments of said secondary storage data and any portion of a corresponding data block of said primary data from which the given fragment of said secondary storage data is based are stored on different storage mediums of said plurality of storage mediums.

23. The system of claim 22, wherein the secondary storage module is further constrained to store said secondary storage data such that the given fragment of said secondary storage data and any portion of the corresponding data block of said primary data from which the given fragment of said secondary data is based are stored on different storage device nodes of said plurality of storage device nodes.
